(19) United States
(12) Patent Application Publication
(10) Pub. No.: US 2019/0120623 A1
(43) Pub. Date: Apr. 25, 2019

(54) Gyroscopic balance unit, 300. and precessional propulsion method

(71) Applicants: Mario F. McGuinness, Bellflower, CA (US); Don M. Kartchner, Temecula, CA (US)

(72) Inventors: Mario F. McGuinness, Bellflower, CA (US); Don M. Kartchner, Temecula, CA (US)

(21) Appl. No.: 15/998,010

(22) Filed: Jun. 8, 2018

Related U.S. Application Data
(63) Continuation-in-part of application No. 14/214,101, filed on Mar. 14, 2014.
(60) Provisional application No. 61/852,183, filed on Mar. 15, 2013.

(51) Int. Cl. G01C 19/18

(52) U.S. Cl. CPC G01C 19/18

(57) ABSTRACT

A gyroscopic balance unit 300, may be described as an apparatus that integrates three or more gyroscopes into one unit, allowing their forces to unite in such a manner that they work together in balanced harmony. This is achieved by applying a processional propulsion method of operation, to the gyroscopic balance unit 300, to harness balance and direct it's gyroscopic forces, in such a way that they flow together and work as a team developing balance gyroscopic precession that takes a spiral path, and pushes in an overall linear direction.

### CROSS-REFERENCE TO RELATED APPLICATIONS

This application claims the benefit of;

Provisional Application Ser. No. 62/603,723 filed Jun. 8, 2017

Utility patent application Ser. No. 14/214,101 filed Mar. 14, 2014

Provisional Application Ser. No. 61/852,183 filed Mar. 15, 2013

### STATEMENT REGARDING FEDERALLY-SPONSORED RESEARCH OR DEVELOPMENT

Not Applicable

### THE NAMES OF THE PARTIES TO A JOINT RESEARCH AGREEMENT

Not Applicable

### INCORPORATION-BY REFERENCE OF MATERIAL SUBMITTED ON A COMPACT DISC

Not Applicable

### BACKGROUND—OF PRIOR ART

| | KIND | | |
|---|---|---|---|
| PAT. NO. | CODE | PATENTEE | ISSUE DATE |
| 4,825,716 | | RANDY ROBERTS | MAT 2, 1989 |
| 7,362,156, B2 | B2 | WILLIAM | FEB. 5, 2008 |
| | | DWORZAN | |
| 7,383,747 | B2 | RAYMOND K, | JAN. 10, 2008 |
| | | TIPPETT | |
| U.S. Pat. No. 7,563,210 | B2 | TOM SMITH | JUL. 21, 2009 |
| U.S. Pat. No. 7,953,035 | B2 | TOM SMITH | MAY 3, 2011 |
| U.S. Pat. No. 8,652,012 | B2 | TOM SMITH | FEB. 18, 2014 |

### SUMMARY

It is an object of the “gyroscopic balance unit and the precessional propulsion method” to house three or more gyroscopic flywheels, that may generate similar magnitudes of force.

The gyroscopic flywheels may be physically positioned relative to each other, in such an arrangement, that during induced gyroscopic precession, forces pushing on one pivotal gimbal axis, could be counteracted by forces from another pivotal gimbal axis.

The arrangement of the pivotal gimbal axis, may be such that together they form a polygon Shape, such as a triangle in one embodiment, or a square, in another, or a pentagon in another and so on.

This type of physical arrangement, allows the “precessional propulsion method of operation” to activate balanced precession simultaneously with in each gyroscopic flywheel.

### BRIEF DESCRIPTION OF DRAWINGS

FIG. 1, Is a perspective view of the Gyroscopic balance unit 300.

FIG. 2, Is an exploded perspective view of a gimbal block assembly 136.

FIG. 3, Is an exploded perspective view of gyro modules 127, being assembled to become a Gyroscopic balance unit 300.

FIG. 4, Is a perspective view of the Gyroscopic balance unit 300, depicting movement and action.

FIG. 5A-5H are a series of views, orthographic and perspective, depicting the pivotal movement of flywheels during balanced gyroscopic precession.

FIG. 6 Is a flowchart, describing the precessional propulsion method of operation in a step by step manner, as it is applied to a Gyroscopic balance unit 300.

FIG. 7, Is a top view of a Gyroscopic balance unit 400.

FIG. 8, Is a top view of a Gyroscopic balance unit 500.

FIG. 9 Is a top view of a Gyroscopic balance unit 600.

FIG. 10 Is a perspective view of an operator 125, applying the precessional propulsion method of operation, to the Gyroscopic balance unit 300, to exercise, and push a box 116, in a vertical direction with surprising thrust.

DRAWING --REFERENCE NUMBERS
PARTS LIST NAMES AND NUMBERS

| 100 | FLYWHEEL |
|---|---|
| 101 | PIVOTAL FEATURES |
| 102 | GIMBAL BLOCK |
| 103 | AXLE |
| 104 | CLOCKWISE DIRECTION |
| 105 | COUNTERCLOCKWISE DIRECTION |
| 106 | THREADED HOLE |
| 107 | BEARING |
| 108 | FLYWHEEL DIAMETER |
| 109 | WINDOW |
| 110 | ARROW |
| 111 | BEARING HOLE |
| 112 | FLYWHEEL THICKNESS |
| 113 | AIR NOZZLE |
| 114 | CENTER HOLE |
| 115 | RECTANGULAR SHAPE |
| 118 | ROUTER |
| 119 | HOLE |
| 120 | BOLT |
| 121 | SOCKET WRENCH |
| 122 | POCKETS |
| 123 | WALL |
| 124 | CONNECTING WALL |
| 125 | OPERATOR |
| 126 | HEX SHAPE |
| 127 | GYRO MODULE |
| 128 | MODULE FRAME |
| 129 | WELD |
| 130 | AIR HOSE |
| H 132 | SHAFT QUARTER INCH |
| 136 | GIMBAL BLOCK ASSEMBLY |
| 9+ | 9:00 O'clock PLUS |
| 12− | 12:00 O'clock MINUS |
| YC | Y axis connection |
| XO | HORIZONTAL PLANE |
| Z | VERTICAL AXIS |
| Z+ | VERTICAL DIRECTION |
| X1 | FLYWHEELS . . . PLANE |
| X2 | FLYWHEELS PLANE |
| X3 | FLYWHEELS .PLANE |
| Y1 | PIVOTAL .AXIS |
| Y2 | PIVOTAL AXIS |
| Y3 | PIVOTAL AXIS |
| 1U | UP, DIRECTION Y AXIS 1 |
| 1D | DOWN, DIRECTION Y AXIS 1 |
| 2U | UP, DIRECTION Y AXIS 2 |
| 2D | DOWN, DIRECTION Y AXIS 2 |
| 3U | UP, DIRECTION Y AXIS 3 |
| 3D | DOWN, DIRECTION Y AXIS 3 |
| SUPPLIERS | |
| STEEL AND ALUMINUM | INDUSTRIAL METAL SUPPLY |
| | 2481 ALT ON PARKWAY |
| | IRVINE CA. 92606 |
| | PH.(949) 250-3343 |

| | | |
|---|---|---|
| BEARINGS, | PART #1293N7 | McMASTER CARR |
| BOLTS, | PART# 91263A768 | 9630 NORWALK BLVD. |
| H AIR NOZZLE, | PART#31875K28 | Santa Fe Springs, CA. 90670 |
| AIR HOSE, | PART#9150K51 | PH. (562) 692-5911 |
| SOCKET | PART#5543A25 | |
| WRENCH, | | |
| ROUTER, BOSCH | PART#35465A61 | |

### DETAILED DESCRIPTION

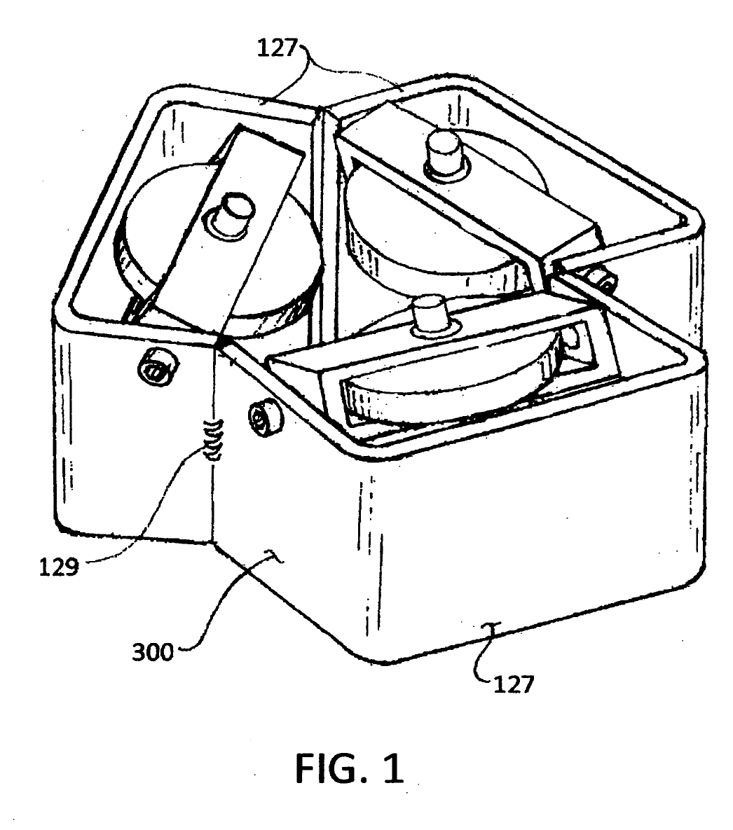

FIG. 1. Is a perspective view of a Gyroscopic Balance Unit 300, It's one of the new embodiment in the gyroscopic balance unit series, that are operated by using the precessional propulsion method. We originally filed a provisional patent application in March 2013, and it was titled the Gyroscopic Balance Unit, and the Precessional Propulsion Method, U.S. application Ser. No. 14/214,101.

These new embodiments are very similar to the original ones, as they work and operate under the same basic concept.

The original invention employed two gyroscopic flywheels working together as a team, to generate linear thrust.

The original gyroscopic balance unit was activated and operated by using what we call the precessional propulsion method of operation, and that same basic method of operation can still be applied to these new embodiments.

Each of the new balanced units is made up of a number of gyro modules 127, that are connected together by a welds 129, this particular embodiment shown here in FIG. 1, has three gyroscopic flywheels, and each flywheel is part of a gyro module.

In our original design two flywheels generated similar magnitude of force, and they worked together as a team to generate linear thrust, but now in these new embodiments we are using three or more flywheels, each generating similar magnitudes of force, and they all are working together as a team to generate linear thrust, in our original embodiments when the precessional propulsion method was applied to a balance unit, opposing torque forces pushed one pivotal gimbaled axis (or axle) against another, to create a condition of balanced stability, this is also true in these new embodiments.

The new embodiments are similar to the original ones in many ways, here is a list of some of the commonalities.

It's all about Balance

Balance magnitudes of force.

Balanced in timing.

A plurality of gyroscopic flywheels working together.

Balance pivotal action and direction.

Balanced opposing torque forces that develop a non tilting condition, we call, torque balanced stability.

Gyroscopic flywheels arranged so that the torque force pushing on one pivotal gimbaled axis, meets with the torque force pushing on another pivotal gimbaled axis.

Balanced gyroscopic precession activated by only one introduced torque force.

Flywheels spin axis may meet in a vertex.

Balanced forces unite to push in a linear direction.

The flywheels planes are arranged in a particular start position.

The flywheels spin in a particular direction.

Substantially symmetrical arrangement of the flywheels.

Balanced gyroscopic precession may be induced by applying a torque force to the balance unit, in the opposite direction that the flywheels are spinning.

Balanced gyroscopic precession develops surprising linear thrust.

A plurality of pivotal gimbaled axis, arranged so they may form a polygon shape.

Some differences between our original and the new embodiments, are different types of flywheel combinations or matching sets, different arrangement of flywheels, and in our original embodiments there was a balance line, and now we have a balance plane.

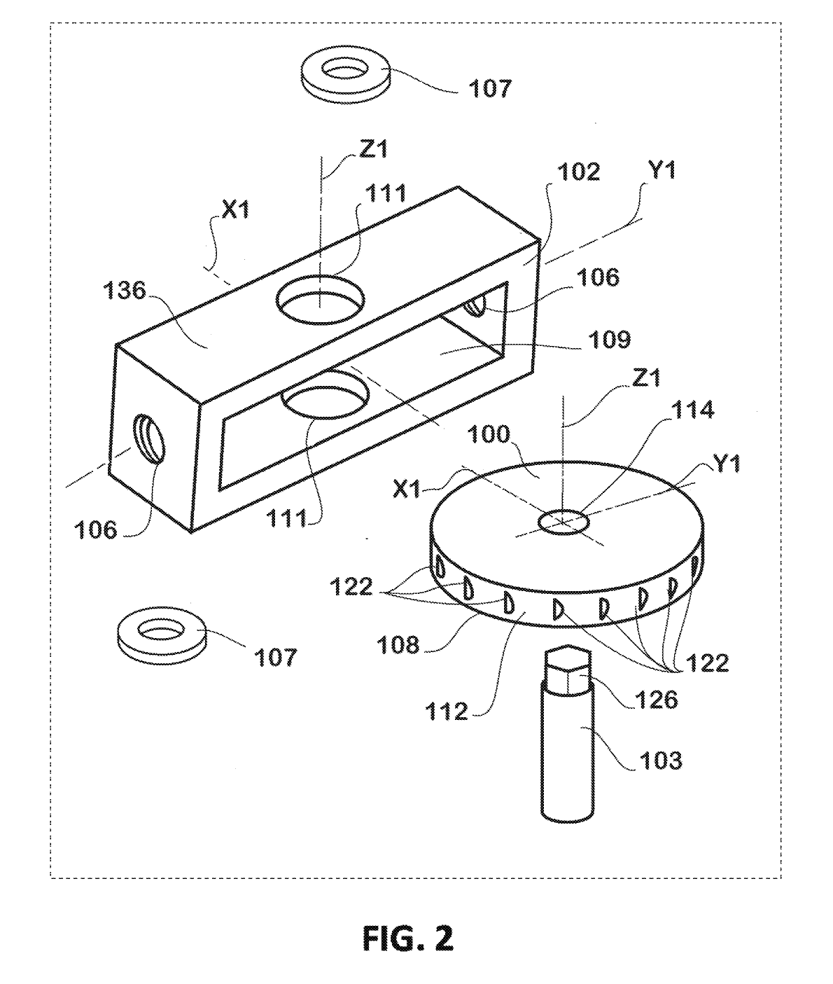

FIG. 2, is an exploded perspective view of a gimbal block assembly 136, as it's being assembled, it may consist of the following components, a flywheel 100, a gimbal block 102, several bearings 107, and an axle 103.
The flywheel is shown with three center lines X1, Y1, and Z1, they are all perpendicular to each other, and meet in the center of the flywheel, the center line Z1, represents the center spin axis of the flywheel.

The X1, and Y1, center lines run through the center of the flywheels diameter 108, and thickness of its plane 112, when the flywheel is inserted into the gimbal block, the center lines follow the flywheel, and they may be centered in the gimbal block, and are shown here extending out of the gimbal block.

The X1 centerline represents the flywheels plane, and the Y1, center line becomes the Y1 axis when they are assembled, and it also represents the pivotal gimbal axis of the gimbal block, and the flywheel,

The sizes, shapes, materials, hardware, motors types, components, speeds, directions, weights, etc, are suggestions and not meant to limit the construction, scope or use of the invention.

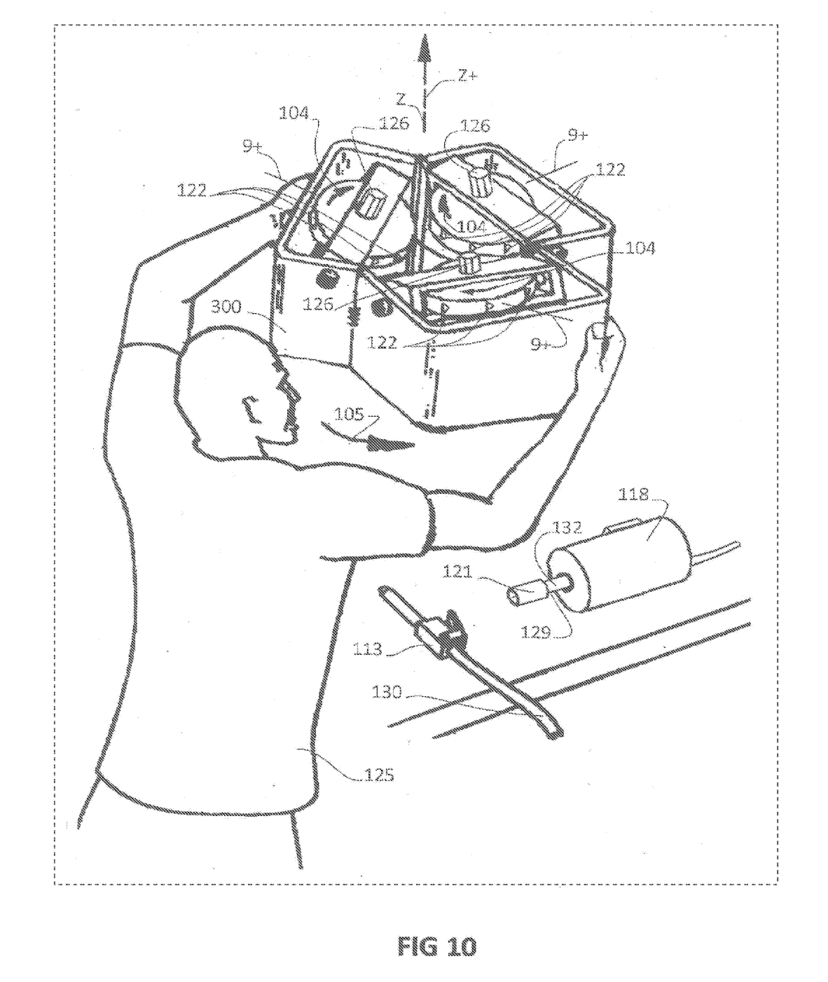

Our prototype was constructed as follows. The flywheel's diameter 108, maybe about five inches, the thickness 112 of its plane, may be near one inch, it's center hole 114, maybe about three eighths of an inch in diameter, and the flywheel may have pockets 122, equally spaced around its diameter, (they are used to catch air, causing the flywheel to spin), as described in FIG. 10.

The flywheel may be made from steel or many other materials, known now or in the future, and may be fabricated using methods, known now or in the future.

its function is to spin fast and generate gyroscopic forces, it may be almost any type of object that can spin fast and generate gyroscopic forces, it could be some type of motor or part of a motor.

When choosing a flywheel of any type, consider its diameter, weight or mass, its speed, and the number of flywheels needed to generate the forces required for a particular pushing or pulling task.

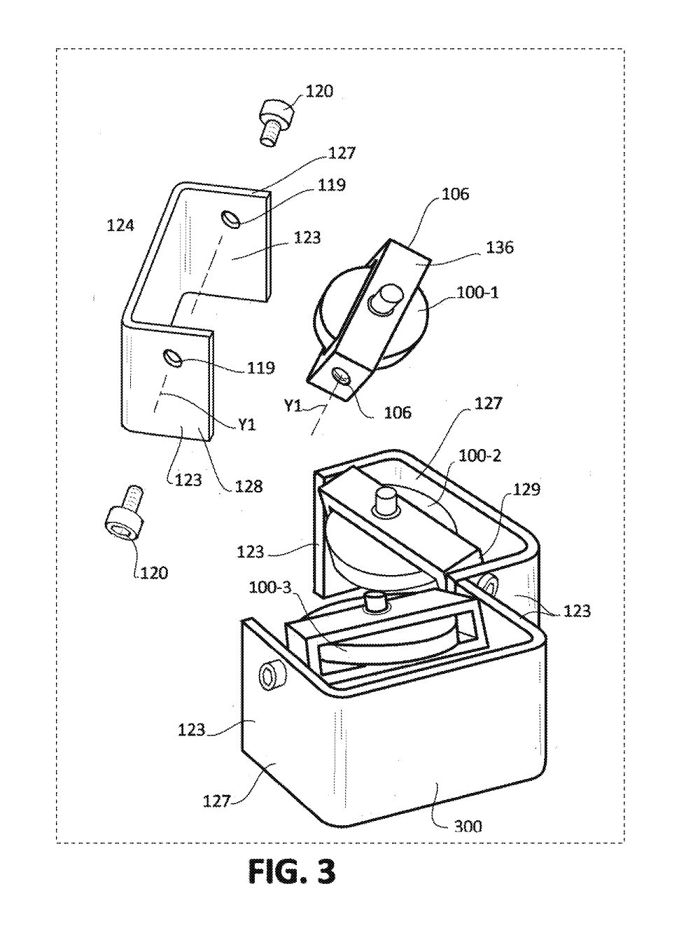

The gimbal block 102, maybe a rectangular shaped block or other shapes, it may be made of aluminum or other materials, it may be fabricated using industrial methods, Its function is to provide support for the flywheels bearings, on its Z1 axis, and provide pivotal support along its Y1 axis, it may be a rectangular shaped block, with a rectangular shaped window opening 109. The window may be sized and positioned so the surrounding wall or frame material is of equal thickness, centering the rectangular shaped window in the rectangular shaped glock. The window should be large enough so the flywheels plane can be centered inside the plane of the window on the Z1, axis, The block should be sized so there is enough material in its height width and depth in the surrounding frame area of the window, for the aligned threaded holes 106, to provide pivotal support along the Y1 axis, and for the two aligned bearing holes 111, on the Z1 axis to provide support for the bearings 107, as they allow the flywheel to spin. (the threaded holes should be sized to fit the bolt 120, and the holes 111 should be sized to be a press fit for the bearings, as shown in FIG. 3.) back to FIG. 2 please. The axle 103, maybe made from steel or other materials, it may be size to be a tight press-fit in the flywheels hole 114, and a medium press fit into the bearings 107, its function is to provide support for the flywheel to spin. it may have a hex shape 126, formed on one end, and it may be long enough, so that it may pass through the holes 111, in the gimbal block and extend out far enough on one end, so the hex shape can extend below the block.

The gimbal block assembly 136, may be assembled as follows.

The flywheel may be placed inside the window in the gimbal block so it's center hole 114 and the holes 111, in the block are aligned, then the axle 103 may be aligned with those holes on the Z1 axis, and then press through the top of the gimbal block and into the flywheel far enough thru the block, so the hex shape may extend below the block. The bearings 107, could then be pressed over the axle and press-fit into the holes 111, one in the top of the block and one in the bottom, when assembled the flywheel should be positioned so its centered in the window and can spin freely, a completed version of the gimbal block assembly is shown in FIG. 3.

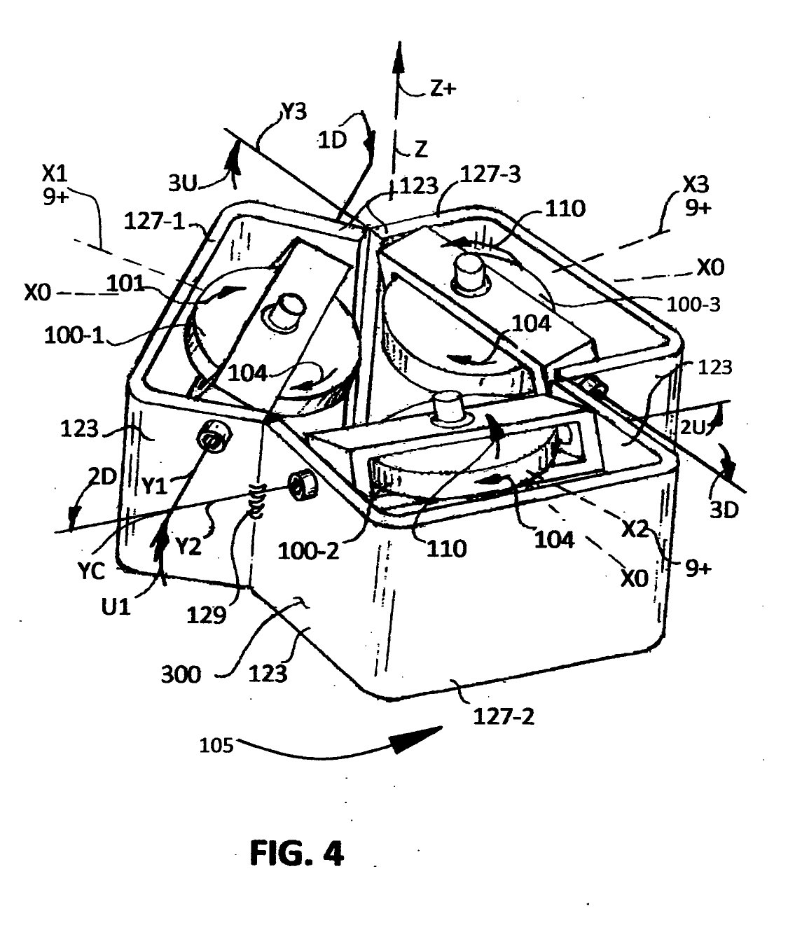

FIG. 3, is an exploded assembly perspective view of a gyro module 127, being assembled, with the gimbal block assembly 136, also shown below are two assembled gyro modules, when all three modules are assembled and welded together they become the gyroscopic balance unit 300. welds are shown in FIG. 1 and FIG. 4.

The module frame 128, may be described as a U-shaped channel, the module frame may be formed in many shapes from many types of material using industrial methods, its function is to provide pivotal support for the gimbal block assembly 136, along its Y1 axis, the walls 123, of the module frame maybe parallel to each other and they may be joined together by a connecting wall 124, the module frame maybe three eighths of an inch thick aluminum sheet, the distance between the walls should be wide enough to fit the gimbal block on its Y1 axis, the Y1 axis is also shown extending out of the module frame, each wall may have a hole 119, that is sized to be a clearance fit for the threads on bolt 120, those holes may be aligned with each other, so that the gimbal block can pivot, while aligned with those holes, on the pivotal Y1 axis.

Assembly for the gyro module, and the balance unit may be as follows.

The gimbal block may be installed in between the two holes 119, and then two bolts 120, could be installed through the holes, and into the two threaded holes 106, in the gimbal block forming a pivotal connection on the Y1 axis. The gimbal blocks should be able to pivot when assembled.

Two fully assembled modules 127, are shown below, they have been positioned in such a way so that when the top module is lowered down to join them, they will form the triangular shape of the gyroscopic balance unit 300, shown in FIG. 1. The weld 129, can be placed where the walls 123, from one gyro module meet with the walls 123, from another gyro module the welds can be repeated around the assembly where the modules connect with each other, to secure them together and become a complete balance unit, as shown in FIGS. 1 and 4. (In manufacturing A number of gyro module frames could be formed together as one piece, eliminating the need for welding.) When gyro modules are connected together forming a balance unit, one module and its parts may be distinguished from another by a different dash numbers being added to its identifying character, for example the flywheel 100-1, 100-2, and 100-3.

FIG. 4,

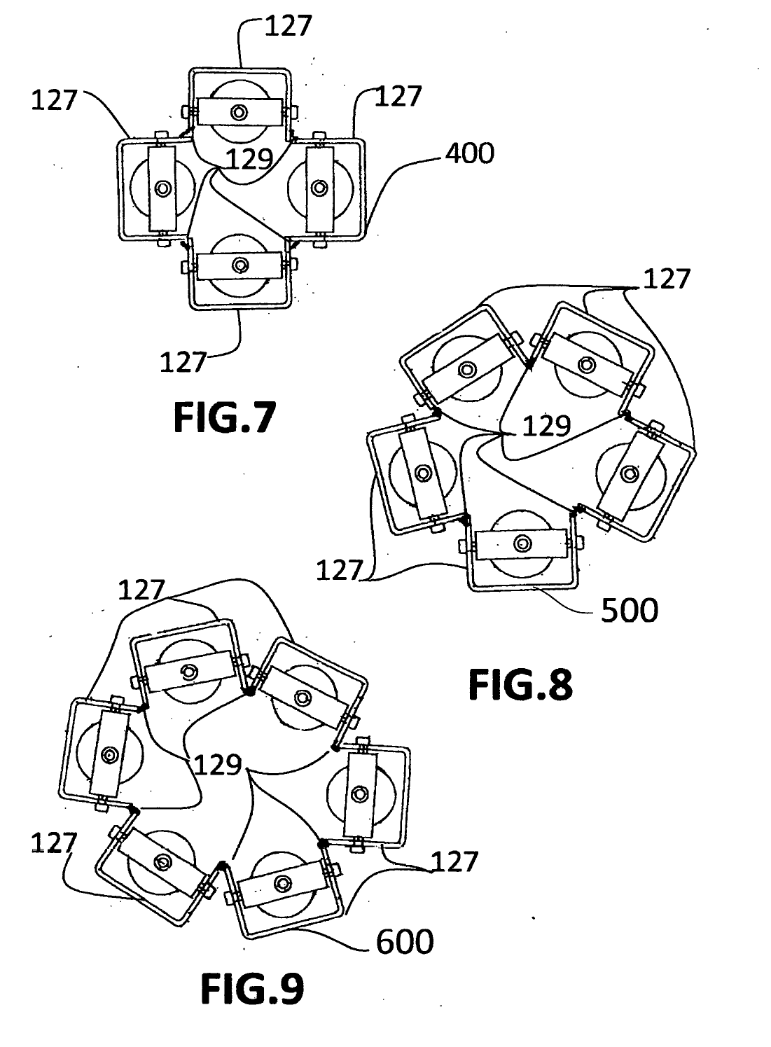

Is a perspective view of the gyroscopic balance unit 300, also shown in FIG. 1, it is the same basic view, but now arrows have been added, to show movement, and the direction of forces. The three pivotal Y axis form a triangular shape, giving the flywheels and their pivotal Y axis a concentric symmetrical arrangement, with a common Z axis, center, this is also true with the other embodiments of different polygon shapes, are shown in FIG. 7, FIG. 8, and FIG. 9.

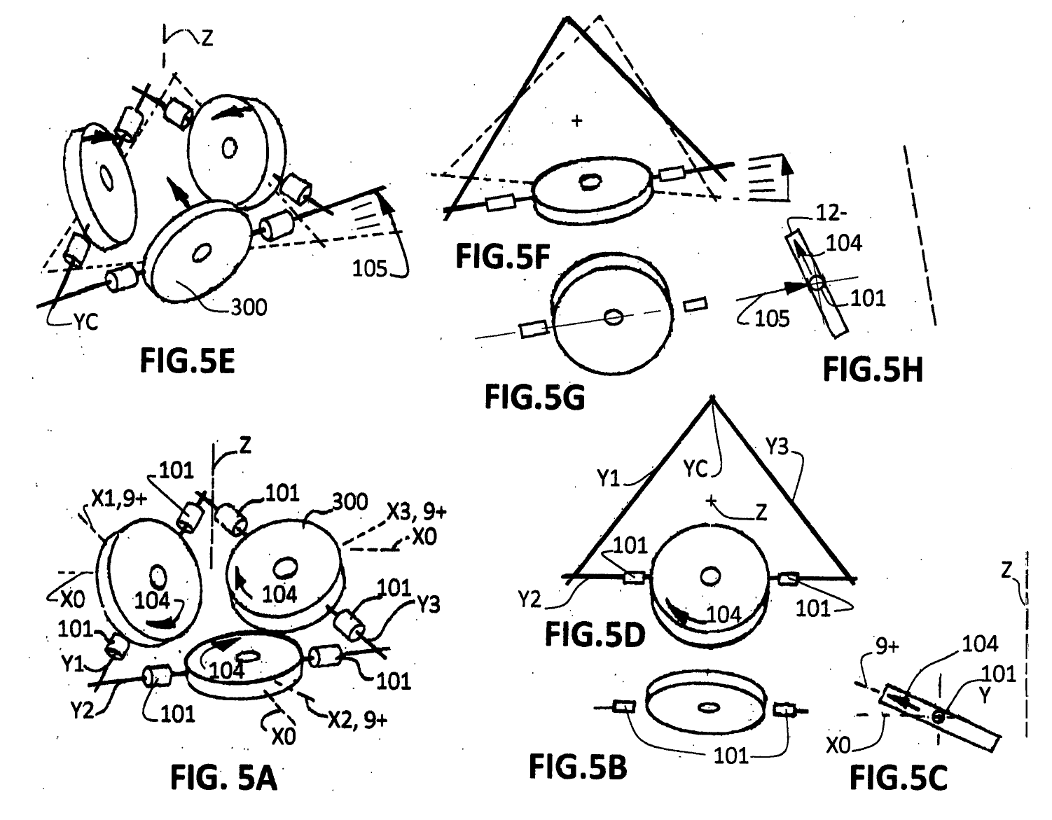

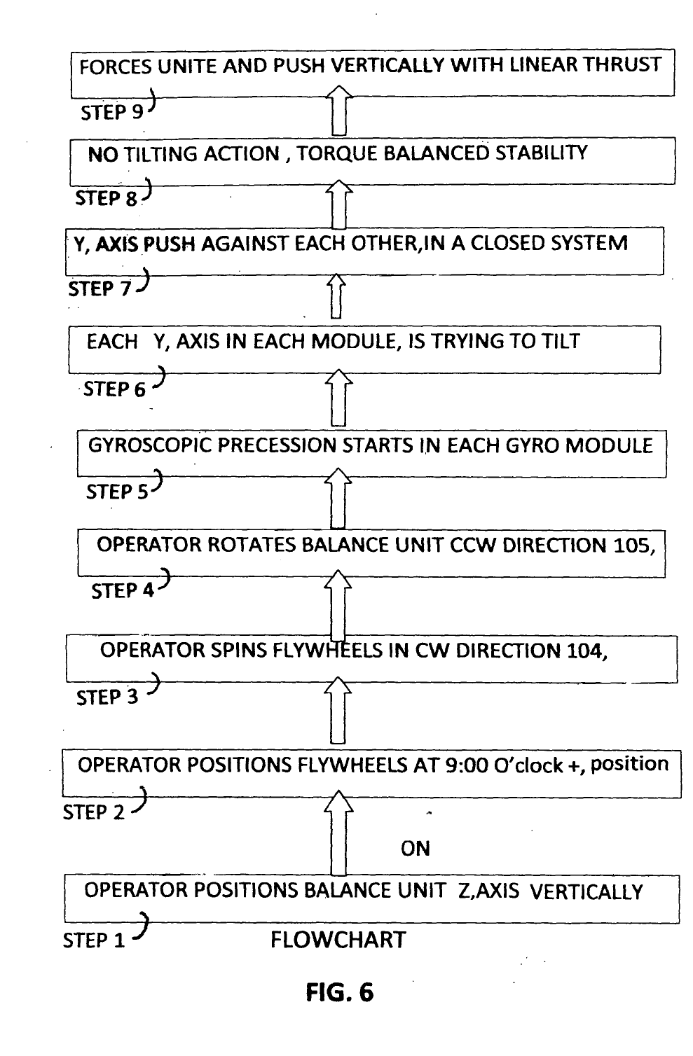

The following is a description of the balance unit as it goes thru induced balanced gyroscopic precession, following the steps described in the flowchart in FIG. 6, and shown in FIGS. 5, A, B, C, D, E, F, G, H, and FIG. 10.

The three flywheels, 100-1, 100-2, and 100-3, are all spinning fast in the same clockwise direction 104, generating similar magnitudes of gyroscopic force, they may all have the same diameter and thickness, and be made of the same type of material, and be spinning at the same high speed. Groups of flywheels like this that produce similar magnitudes of force and work together as a team may be described as a matching set. The pivotal position of their planes X1, X2, and X 3, is tilted slightly above a horizontal plane XO, we call this the start position 9:O'clock plus indicated by the characters 9+, and it is also shown in an orthographic view in FIG. 5D.

With the flywheels pivotally tilted at an angle and spinning fast, then a torque force can be introduced to turn the balance unit in the opposite direction that the flywheels are spinning, which is the counterclockwise direction 105, this action induces gyroscopic precession within each gyro module, 127-1, 127-2, and 127-3, “.but there is much more to it than that” considering the fact that, the pivotal Y axis in these gyro modules are supported by the walls 123, and the walls from one gyro module, are connected to the walls from another gyro module by the welds 129, that are repeated around the balance unit, this forms a closed physical connection from one pivotal axis to another, creating this triangular shaped pivotal Y axis connection, we call the YC connection, and we identify that connection with the letters YC, this type of connection can take many forms, this triangular shape in this embodiment, is just one example, the YC connection is also found in the other embodiments and their polygon shapes, shown in FIGS. 7, 8, and 9.

The YC connection provides the type of physical support that allows opposing forces to generate a type of non tilting flat plane or a platform, creating the condition we call, torque balanced stability. It also allows separate gyroscopic precessional actions and forces to combine, so they work together in harmony developing BALANCED gyroscopic precession.

During balanced gyroscopic precession powerful forces unite and push together to generate linear thrust.

Torque balanced stability, is described in greater detail.

As the three flywheel start to pivot upward in the direction of the arrows 110, rotational torque forces are pushing on the pivotal gimbal axis Y1, Y2, and Y3, those forces push up on one end, and down on the other of each pivotal axis. The letter U, indicates the direction up, and the letter D, indicates the direction down. (along with their arrows). The word axis, not only represents a centerline of rotation, but it may also refer to the actual physical element that surrounds that axis, thus axle and axis could be thought of as being basically the same, throughout these pages.

The pivotal axis Y1, has an arrow 1U, on one end, and on the other end an arrow 1D, the pivotal axis Y2, has an arrow 2U, on one end, and on the other end an arrow 2D, the pivotal axis Y3, has an arrow 3U, on one end, and on the other end an arrow 3D. Torque forces generated during induced gyroscopic precession can push on those axis in the following manner, one end of the Y1 axis is pushing up (1U), and it is pushing against one end of the Y2, axis that is pushing down (2D), the other end of the Y1 axis, is pushing down (1D), against one end of the Y3 axis, that is pushing up (3U), and one end of the Y2 axis, is pushing up (2U) against the other end of the Y3 axis, that is pushing down (3D).

The torque forces are pushing up on one end, and down on the other, on each and every axis creating a closed torque system, they are all trying to rotate in the same direction, causing torque force, from one gyro module to oppose the torque force from another gyro module, forces on all three modules are trying to tilt the balance unit simultaneously, but they can't as those torque forces are substantially equal, and they oppose each other, in a closed system together they develop, “torque balance stability”. (this type of closed system is also found in the other embodiments with different polygon shapes shown in FIGS. 7,8, and 9, as a result,) no tilting action occurs but tremendous forces are still pushing, as the balance unit is still being rotated, about its Z axis, and the fast spinning flywheels continue to pivot, gyroscopic forces unite and push together in a linear direction, the balance unit pushes vertically in the Z+ direction with such thrust, that the operator can't feel the weight of the balance unit (as shown in FIG. 10).

(An additional torque, force may be applied to the bolts, gimbal blocks or other areas to pivotally rotate the spinning flywheels in the direction of the arrows 101, these torque forces, may be applied by man or machine, and they may be applied while the balance unit is being rotated on its Z axis, or not being rotated at all. This action can also generate balanced gyroscopic precession.)

FIG. 5A, is a perspective view of the three flywheels, and pivotal features that are part of the gyroscopic balance unit 300, this is the first in a series of perspective and orthographic views that are all linked together, depicting the pivotal action of the flywheels, as they go thru balanced gyroscopic precession. The only physical parts that are shown in these views are the flywheels, and then the small cylindrical shape blocks we call pivotal features 101, which actually represent not one particular part, but a combination of parts, that together provide pivotal means along the Y axis for the flywheel and the gimbal block, such as shown in FIG. 3, as the bolt 120, goes thru the hole 119, in the module frame, 128 and is then screwed into the threaded hole 106, in the gimbal block 102, the bolt is not screwed in so far or tight, that it stops the gimbal block from pivoting, this assembly forms a pivotal connection, the combination of these parts and their connection, are represented by what we call the pivotal feature 101. Six pivotal features are connected together, by the fact that a module frame from one gyro module, is welded to another module frame, from another gyro module, this arrangement forms the Y axis connection, YC and is also shown in FIG. 4.

(Now back to FIG. 5 please)

The long dark solid lines represent the pivotal gimbal Y axis, of each flywheel the axis Y1, Y2, and Y3. A vertical centerline Z, is also shown, it may roughly represents the center axes that the balance unit, may be rotated around, (by an introduced torque force, to induce precession)

The flywheels are placed in a tilted start position 9:00 O'clock plus, identified by the characters 9+, placing their planes X1, X2, and X3, all pivotally tilted above the horizontal plane XO.

The flywheels are all spinning fast in the same clockwise direction 104, generating similar magnitudes of force.

FIGS. 5B, 5C, and 5D, are all orthographic views taken from the isometric view in FIG. 5A. (only one flywheel is shown in these orthographic views) so they are not overly complicated or crowded.

FIG. 5D, is a top view.

One flywheel is shown in a tilted position, it's spinning in the clockwise direction 104, it's pivotal features 101 are shown along its pivotal Y2 axis, and the two other pivotal Y axis, Y3 and Y1, are also shown, together they form a triangular shape, that forms the YC, connection. The vertical center line Z, is seen from the top. (as a plus shape,)

FIG. 5B. is a front view projected from the top view FIG. 5D, the flywheel is shown in a tilted position and is supported by the pivotal features 101.

FIG. 5C.

Is a side view projected from the front view 5B, the flywheel is shown spinning in the clockwise direction 104 and tilted in a near horizontal position above the horizontal plane XO, and the pivotal feature 101, is shown from an end view, this is the view that shows the (9:00 O'clock plus), 9+, start position best. The pivotal feature 101 could be thought of as the center of a clock, and the flywheels plane could be thought of as the hour hand on the clock. As the clock's hour hand can rotate, the flywheel can pivot, on its pivotal Y axis. The vertical center line Z is shown as a reference point.

FIG. 5E,

FIG. 5E, is a perspective view of the balance unit 300, this figure is similar to FIG. 5A, but in this view a torque force is introduced in a counterclockwise direction 105, that has rotated the balance unit, on its Z axis (with its flywheels spinning fast and tilted) this introduced torque force induces balanced gyroscopic precession,

This torque force changes the position of the Y axis connection YC, from its original position shown here in short dashed lines, to a new position shown here in long dark solid lines, now the three spinning flywheels start to pivot upwards as precession is taking place.

FIG. 5F, 5G, AND 5H, are all orthographic views, taken from FIG. 5E, again only one flywheel is shown in these orthographic views.

FIG. 5F, is a top view of FIG. 5E, and FIG. 5G, is a front view projected from FIG. 5F.

FIG. 5H. is a side view projected from FIG. 5G.

In FIG. 5H, the pivotal position of the flywheels plane is near vertical, what we call the (12:00 O'clock minus) position, identified by the characters 12. The flywheel has pivoted during precession, from a near horizontal position, to a near vertical position. the introduced torque force pushes in the counterclockwise direction 105, against the pivotal feature 101, while the flywheel is spinning in the clockwise direction 104, these opposing directions generate very powerful gyroscopic precessional forces,

Operation

The manner of using the gyroscopic balance unit 300 to exercise or to apply a pushing force. A person actually operating the gyroscopic balance unit 300 is shown in FIG. 10. FIG. 6, Is a flowchart describing the step-by-step method of operation that we call the precessional propulsion method, it would be applied to the gyroscopic balance unit 300, (shown in FIG. 4,) as well as the other balance units 400, 500, 600, etc (shown in FIGS. 7,8, and 9,).

(These steps may be taken by man, or machine or a combination of the two.)

This method of operation may be followed by the operator 125, shown in FIG. 10 Methods described in FIG. 10 could be used in these steps, such as methods used to spin the flywheels, only some of these steps are taken by the operator, while other steps are reactions to those steps,

Step 1.

The operator 125, could position the balance unit, so its Z axis, is in a vertical position. (This is an optional step, as the balance unit could be activated and push in any direction that its Z axis is in, the steps would follow the orientation of the Z axis)

Step 2.

The flywheels may be positioned so their planes are at opposing angles, and are tilted above the horizontal plane, we call this position, (the start position 9:00 O'Clock plus.)

Step 3.

The flywheels can be spun at a fast rate, in the clockwise direction 104, generating similar magnitudes of gyroscopic force (by methods described in FIG. 10

Step 4.

the operator starts to rotate the balance unit in the counterclockwise Direction 105, upon its Z axis.

Step 5.

Starting to rotate the balance unit, (with its flywheels tilted and spinning) starts to induce gyroscopic precession within each gyro module, the flywheels start to pivot upward further away from the horizontal plane, (these steps 5, 6, 7, 8, and 9, are basically taking place simultaneously and may be considered as one reaction, to the steps taken earlier.)

Step 6.

The pivotal Y axis within each gyro module tries to tilt, due to the torque forces pushing on them

Step 7.

The physical arrangement of the Y axis connection, (shown in FIG. 4) allows the torque force pushing on one pivotal Y axis, to push against the torque force on another pivotal Y axis. (in a closed system)

Step 8.

The opposing and equal torque forces create a balanced condition that stops tilting action from occurring we call this (torque balanced stability.)

Step 9.

With the balance unit in a stable non tilting condition, (but still being rotated), the fast spinning flywheels continue to pivot, and powerful gyroscopic forces continue pushing, together these forces push in a direction that is perpendicular to the rotation of the balance unit in the vertical linear direction with surprising thrust.

THE GYROSCOPIC BALANCE UNITS are BALANCED in many ways.
(A) THE PHYSICAL ARRANGEMENT OF THE FLYWHEELS, AND THEIR PIVOTAL GIMBALED Y AXIS, are symmetrical, concentric and may form a polygon shape.
(B) THE FORCES THAT EACH FLYWHEEL GENERATES. Are equal
(C) THE PIVOTAL POSITION OF THE FLYWHEELS, BEING TILTED ABOVE THE HORIZONTAL PLANE. Induces precession evenly
(D) OPPOSING TORQUE FORCES IN A CLOSED SYSTEM creates stability.
(E) THE DIRECTION OF THE GYROSCOPIC FORCES. Are united (A), (B), (C), (D), and (E), ARE ALL BALANCED CONDITIONS, THAT TOGETHER CONTRIBUTE TO GENERATING BALANCED GYROSCOPIC PRECESSION, AND LINEAR THRUST.

### Additional Embodiments

FIGS. 7, 8, AND 9,

FIG. 7, is a top view of a new gyroscopic balance unit 400, it is similar to the gyroscopic balance unit 300, (shown in FIG. 1) which has a triangular shape with three gyro modules, but in this new balance unit 400, one more gyro module 127, has been added to the number of gyro modules giving it this new square shape, the gyro modules could then be held together by the weld 129, repeated around the assembly were the gyro modules meet, similar to what is shown in FIG. 1 (the welds are barely visible in these top views)

FIG. 8. is a top view of the gyroscopic balance unit 500, it is much the same as the gyroscopic balance unit 400, shown in FIG. 7, but another gyro module 127, has been added, giving it a type of pentagon shape, and of course those gyro modules have been welded together, by the weld 129, being repeated around the assembly.

FIG. 9. is a top view of the gyroscopic balance unit 600, it is much the same as the gyroscopic balance unit 500, shown in FIG. 8, but one more gyro module 127, has been added giving it a new hexagon shape, and of course these gyro modules have been welded together. by the weld 129, being repeated around the assembly.

Many more gyro modules could be joined together, making even more new embodiments.

These embodiments and ones not shown, may form geometric or polygon shapes with the arrangement of their gyro modules and their pivotal Y axis, and those axis could form a Y axis connection, that is a closed system that develops a type of balanced plane, (as mentioned in Fig.), allowing all the embodiments to be operated by using the precessional propulsion method.

FIG. 10,

FIG. 10. is a perspective view of an operator 125, using the gyroscopic balance unit 300, to exercise his muscles, by rotating the balance unit upon its Z axis, and at the same time, trying to stop it from lifting up, the more he rotates it the more it pushes up, he is operating the balance unit using the precessional propulsion method described in FIGS. 4, and 5, and in the flowchart in FIG. 6, first he positions the balance unit so its Z axis is vertical, then he positions the flywheels in the start position 9:00 O'clock plus, 9+, and then he gets each of the flywheels spinning at a high-speed in the clockwise direction 104 by using a air nozzle 113, to blow air at the pockets 122, that are formed around the flywheels diameter, the air nozzle is connected to end air hose 130, that is connected to an air compressor (not shown)—To spin the flywheels even faster, the operator could use a router 118, the router has a steel shaft 132, that is a quarter of an inch in diameter and about one inch long, one end of the shaft is installed into the router, where a router bit would normally go, and the other end of the shaft has a small socket wrench 121, attached to it by the weld 129.

The hex shape 126, on the flywheels axle is sized to fit the socket wrench.

To spin the flywheels, the operator could position the socket wrench over to hex shape on the flywheels axle, then turn on the router and spin the flywheel up to a high-speed, he could then pull the socket and a router off the hex shape, while the router and the flywheel are still spinning, and then turn the router off, he could repeat this operation on the other flywheels. When all the flywheels are spinning fast in the clockwise direction 104, and they are tilted at the 9:00 O'clock plus, 9+ start position, the operator can rotate the balance unit about its Z axis in the counterclockwise direction 105, and that induces balanced gyroscopic precession causing the balance unit to start pushing in a vertical linear direction Z+, with surprising thrust. All of the balance units can push or pull in any direction, and can be used in many different applications.

Advantages

Several advantages of one or more aspects are as follows: to provide an apparatus that pushes in a different fashion than any other machine, one example would be that you could hold on, to the gyroscopic balance unit 300 while it's running, and then start to rotate it, and feel it push away from you in a spiral linear direction, with surprising force, this unique type of pushing machine could have many uses, as pushing is a very common action at home and industry.

### CONCLUSION, RAMIFICATIONS, AND SCOPE

The gyroscopic balance unit 300, and its other embodiments, can be used in many ways, some are obvious like exercising, or just feeling it push, in a spiral linear motion is surprising.

But they may also be used, to push or pull, or apply a force, or pressure, in any direction or assist in these actions. or assist in pushing, horizontally or even downward, many unforeseen uses will be found by industry.

Harnessing powerful gyroscopic forces can open many doors.

1.-8. (canceled)

9. A gyroscopic balance unit 300, comprising:
support means, for a plurality of gyroscopic flywheels, and their pivotal gimbal axis;
said axis, are positioned to allow precessional torque forces on them to interact; and
said flywheels, are capable of generating similar magnitudes of force.

10. The gyroscopic balance unit 300 of claim 9, wherein said pivotal gimbal axis substantially intersect.

11. The gyroscopic balance unit 300 of claim 9, wherein said pivotal gimbal axis form a substantially polygon shape.

12. The gyroscopic balance unit 300 of claim 9, wherein said precessional torque forces oppose each other.

13. A method of producing spiral linear motion, using a gyroscopic balance unit 300; comprising the steps:
providing a plurality of gyroscopic flywheels having gimbal axes;
spinning the flywheels;
generating substantially similar magnitudes of force;
rotating their pivotal gimbal axis;
simultaneously inducing precession; and
producing a spiral linear motion.

14. The method of claim 13, wherein said flywheels, are spinning in the same clockwise direction.

15. The method of claim 13, wherein said pivotal gimbal axis, are rotated in the opposite clockwise direction that the flywheels are spinning.

16. The method of claim 13, wherein said flywheels are positioned at an incline.
